(19) United States
(12) Patent Application Publication
(10) Pub. No.: US 2021/0054637 A1
(43) Pub. Date: Feb. 25, 2021

(54) SUPPORT APPARATUS FOR USE IN CIVIL CONSTRUCTION

(71) Applicant: WENJUAN LU, SHENZHEN (CN)

(72) Inventor: LIN WU, SUZHOU (CN)

(21) Appl. No.: 16/977,465

(22) PCT Filed: Dec. 12, 2018
(86) PCT No.: PCT/CN2018/120726

§ 371 Date: Sep. 1, 2020

(30) Foreign Application Priority Data
Dec. 11, 2018 (CN) 201822075718.3

(51) Int. Cl. E04G 1/24; E04G 1/15

(52) U.S. Cl. CPC E04G 1/24; E04G 1/15

(57) ABSTRACT

A support apparatus for use in civil construction includes a base (1), hydraulic support rods (2) installed at four corners on the bottom of the base (1), a pulley (3) installed at an inner side of the hydraulic support rods (2), a first motor (5) installed at the bottom of the base (1), a transmission wheel (6) provided in the middle portion of a transmission shaft (4), threaded rods (7) disposed at two ends of the transmission shaft (4). A hydraulic cylinder (9) is installed at the top of the base (1). A hydraulic station (10) is installed at a side of the hydraulic cylinder (9), and a support base (11) is fixed on the top of the hydraulic cylinder (9). A second motor (12) is installed at an end of the support base (11), and a lead screw (18) is installed inside the support base (11) at the center.

### BACKGROUND

### 1. Technical Field

The present disclosure generally relates to building auxiliary devices field, and especially relates to a supporting device for use in civil construction.

### 2. Description of Related Art

In civil engineering construction, the most common method is to transport earth, water, tools and other building materials to a required location. Generally, these tools need to be transported from a low place to a high place by generally using cranes. However, this method is great inconvenience in a high construction. In view of an efficiency problem, cement, concrete and various building materials cannot be supported for a long time, which are generally needed auxiliary support tools to support these materials. In addition, construction personnel also need to use the auxiliary support tools to support the material to reach a construction position. However, a current auxiliary support device has great inconvenience to adjust positions of materials according to actual needs, and have great labor intensity.

### SUMMARY

The technical problems to be solved: in view of the shortcomings of the related art, the present disclosure provides to a supporting device for use in civil construction which can effectively solve the problem that a current auxiliary support device has great inconvenience to adjust positions of materials according to actual needs, and have great labor intensity.

The technical solution adopted for solving technical problems of the present disclosure is:

a supporting device for use in civil construction of the present disclosure includes a base, hydraulic support rods installed on bottom four corners of the base, a pulley installed on an inner side of the hydraulic support rod, a transmission shaft installed on an inner side of the pulley, a control panel mounted on the top of one end of the base and a first motor mounted on the middle of a bottom end of the base; a transmission wheel mounted on the middle of the transmission shaft and a pair of threaded rods respectively mounted on two ends of the transmission shaft; the first motor connected with the transmission wheel through a transmission belt; a hydraulic cylinder installed in the middle of a top end of the base, a hydraulic station installed on one side of the hydraulic cylinder, and a support base fixed on the top of the hydraulic cylinder, a second motor installed at one end of the support base, and a lead screw installed in an inner middle of the support base, and a pair of guiding posts respectively installed on both sides of the lead screw, a mounting block sleeved around the lead screw and the pair of guiding posts and including a plurality of bolt holes evenly formed thereon. A moving block is fixed on the mounting block by bolts, and the top of the moving block is connected with a carrier support.

Preferably, a hydraulic tank is installed on an inner side of the hydraulic station, a bidirectional gear pump is installed on one side of the hydraulic tank, and a third motor is installed on one side of the bidirectional gear pump.

Preferably, the mounting block includes a through-hole and a threaded hole respectively corresponding to the lead screw and the guiding post.

Preferably, the bidirectional gear pump is respectively connected with the hydraulic support rod and the hydraulic cylinder through a high pressure-oil pipe.

Preferably, the first motor, the second motor and the third motor are electrically connected to a corresponding control switch of the control panel, respectively.

Preferably, the hydraulic tank includes an oil port formed on the top thereof, and a sealing cover covered onto the oil port.

The present disclosure provides the advantages as below.

The present disclosure can conveniently adjust a height and a horizontal position of the carrier support, easily move the carrier support, and reduce labor intensity when the carrier support is supported, and have advantages of a novel structure and an ingenious conception.

### BRIEF DESCRIPTION OF THE DRAWINGS

In order to more clearly understand the present disclosure, attached drawings described below are a part of the present disclosure specification to interpret the present disclosure together with embodiments of the present disclosure, which will not constitute limitations of the present disclosure. In the accompanying drawings:

FIG. 1 is a schematic view of a supporting device for use in civil construction of the present disclosure.

FIG. 2 is a schematic view of a driving shaft of the supporting device for use in civil construction of the present disclosure.

FIG. 3 is a schematic view of a hydraulic station of the supporting device for use in civil construction of the present disclosure.

FIG. 4 is an installation schematic view of a lead screw of the supporting device for use in civil construction of the present disclosure.

The element labels according to the embodiment of the present disclosure shown as below:

1 base, 2 hydraulic support rod, 3 pulley, 4 transmission shaft, 5 first motor, 6 transmission wheel, 7 threaded rod, 8 transmission belt, 9 hydraulic cylinder, 10 hydraulic station, 11 support base, 12 second motor, 13 moving block, 14 load supporting member, 15 hydraulic tank, 16 bidirectional gear pump, 17 third motor, 18 lead screw, 19 guiding post, 20 mounting block, 21 bolt hole, 22 control panel.

### DETAILED DESCRIPTION

Reference will now be made in detail to embodiments, examples of which are illustrated in the accompanying drawings 1-4.

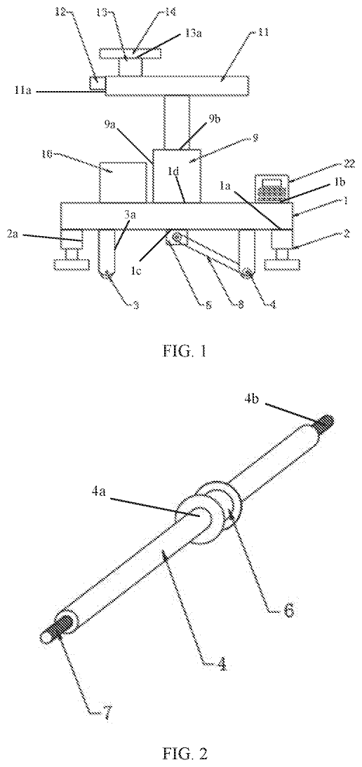

Referring to FIG. 1 and FIG. 2, a supporting device for use in civil construction according to a first embodiment of the present disclosure includes a base 1, hydraulic support rods 2 installed on bottom four corners of the base 1, a pulley 3 installed on an inner side of the hydraulic support rod 2, a transmission shaft 4 installed on an inner side of the pulley 3, a control panel 22 mounted on the top of one end of the base 1 and a first motor 5 mounted on the middle of a bottom end of the base 1: a transmission wheel 6 mounted on the middle of the transmission shaft 4 and a pair of threaded rods 7 respectively mounted on two ends of the transmission shaft 4; the first motor 5 connected with the transmission wheel 6 through a transmission belt 8; a hydraulic cylinder 9 installed in the middle of a top end of the base 1, a hydraulic station 10 installed on one side of the hydraulic cylinder 9, and a support base 11 fixed on the top of the hydraulic cylinder 9, a second motor 12 installed at one end of the support base 11, and a lead screw 18 installed in an inner middle of the support base 11, and a pair of guiding posts 19 respectively installed on both sides of the lead screw 18, a mounting block 20 sleeved around the lead screw 18 and the pair of guiding posts 19 and including a plurality of bolt holes 21 evenly formed thereon. A moving block 13 is fixed on the mounting block 20 by bolts, and the top of the moving block 13 is connected with a carrier support 14.

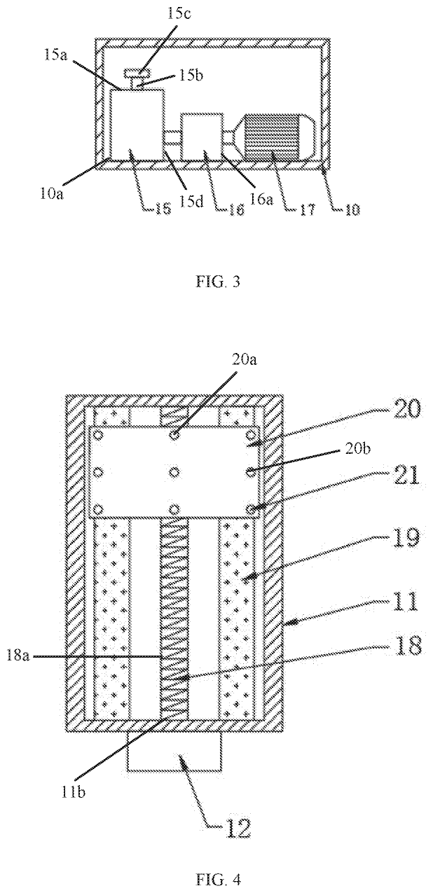

Referring to FIG. 1 and FIG. 3, based on the first embodiment of the present disclosure, a second embodiment of the present disclosure is provided that a hydraulic tank 15 is installed on an inner side of the hydraulic station 10, a bidirectional gear pump 16 is installed on one side of the hydraulic tank 15, and a third motor 17 is installed on one side of the bidirectional gear pump 16. When using the supporting device, the third motor 17 drives the bidirectional gear pump 16 to work and then transfer hydraulic oil in the hydraulic tank 15 to the hydraulic support rod 2 or the hydraulic cylinder 9, or transfer the hydraulic oil in the hydraulic support rod 2 or the hydraulic cylinder 9 back to the hydraulic tank 15.

Referring to FIG. 1 and FIG. 4, based on the first embodiment of the present disclosure, a third embodiment of the present disclosure is provided that the mounting block 20 includes a through-hole and a threaded hole respectively corresponding to the lead screw 18 and the guiding post 19 so as to conveniently install the mounting block 20 and the lead screw 18 and the guiding post 19.

Based on the second embodiment of the present disclosure, a fourth second embodiment of the present disclosure is provided that the bidirectional gear pump 16 is respectively connected with the hydraulic support rod 2 and the hydraulic cylinder 9 through a high pressure-oil pipe so as to facilitate the transmission and use of hydraulic oil.

Based on the second embodiment of the present disclosure, a fifth second embodiment of the present disclosure is provided that the first motor 5, the second motor 12 and the third motor 17 are electrically connected to a corresponding control switch of the control panel 22, respectively, so as to facilitate the transmission and use of signals.

Referring to FIG. 1 and FIG. 3, based on the first embodiment of the present disclosure, a sixth embodiment of the present disclosure is provided that the hydraulic tank 15 includes an oil port formed on the top thereof, and a sealing cover covered onto the oil port. The oil port is provided for conveniently adding hydraulic oil into the support device, and the sealing cover is provided for conveniently sealing the oil port.

A working principle is shown below: when the support device of the present disclosure is used, the first motor 5 can be controlled to work through a corresponding control switch arranged on the control panel 22 when the support device is needed to be moved. And then, the transmission belt 8 and the transmission wheel 6 can be driven to rotate by the first motor 5 and the pulley 3 installed on two ends of the threaded rod 7 is driven to follow rotating to move the support device. After the support device is moved to a specified location, the first motor 5 is shut down, and the third motor 7 is controlled to work via the control panel 22, and then the bidirectional gear pump 16 is driven to follow working so as to transport the hydraulic oil from the hydraulic tank 15 to the hydraulic support rod 2. At this time, the hydraulic support rod 2 reaches out and touches the ground, and the pulley 3 leaves the ground in order to increase an overall stability of the support device. When using the support device, civil building materials can be placed on the carrier support 14, the third motor 17 can drive the bidirectional gear pump 16 to work. When the hydraulic oil is transported from the hydraulic tank 15 to the hydraulic cylinder 9 via the bidirectional gear pump 16, the hydraulic cylinder 9 is extended outward to raise the support base 11 and the carrier support 14. When the hydraulic oil is transported from the hydraulic cylinder 9 back to the hydraulic tank 15 via the third motor 17, the hydraulic cylinder 9 is contracted to drop down the support base 11 and the carrier support 14, thereby the height of the carrier support 14 can be conveniently adjusted. At the same time, the second motor 12 is opened by a corresponding control switch arranged on the control panel 22, the second motor 12 drives the lead screw 18 to rotate so that the mounting block 22 is also driven to move on the lead screw 18, and then the moving block 13 and the carrier support 14 are further driven to move along the lead screw 18, thereby a lateral movement of the carrier support 14 can be conveniently obtained. The guiding post 19 is provided to improve the stability of the support device during moving the support device.

The present disclosure can conveniently adjust a height and a horizontal position of the carrier support, easily move the carrier support, and reduce labor intensity when the carrier support is supported, and have advantages of a novel structure and an ingenious conception.

Finally, it should be noted that: the above description is only the preferred embodiment of the present disclosure rather than constitute limitations of the present disclosure. Although the features and elements of the present disclosure are described as embodiments in detail, for one of ordinary skill in the related art, each feature or element can be used alone or in other various combinations within the principles of the present disclosure to the full extent indicated by the broad general meaning of the terms in which the appended claims are expressed. Any variation or equivalent replacement or improvement made by one of ordinary skill in the related art without departing from the spirit of the present disclosure shall fall within the protection scope of the present disclosure.

1. A supporting device for use in civil construction comprising: a base (1), hydraulic support rods (2) installed on bottom four corners (1a) of the base (1), a pulley (3) installed on an inner side (2a) of the hydraulic support rod (2), a transmission shaft (4) installed on an inner side (3a) of the pulley (3), a control panel (22) mounted on the top of one end (1b) of the base (1) and a first motor (5) mounted on the middle of a bottom end (1c) of the base (1); a transmission wheel (6) mounted on the middle (4a) of the transmission shaft (4) and a pair of threaded rods (7) respectively mounted on two ends (4b) of the transmission shaft (4); the first motor (5) connected with the transmission wheel (6) through a transmission belt (8); a hydraulic cylinder (9) installed in the middle of a top end (1d) of the base (1), a hydraulic station (10) installed on one side (9a) of the hydraulic cylinder (9), and a support base (11) fixed on the top (9b) of the hydraulic cylinder (9), a second motor installed at one end (11a) of the support base (11), and a lead screw (18) installed in an inner middle (11b) of the support base (11), and a pair of guiding posts (19) respectively installed on both sides (18a) of the lead screw (18), a mounting block (20) sleeved around the lead screw (18) and the pair of guiding posts (19), and comprising a plurality of bolt holes (21) evenly formed thereon; and wherein
a moving block (13) is fixed on the mounting block (20) by bolts, and the top (13a) of the moving block (13) is connected with a carrier support (14).

2. The supporting device for use in civil construction as claimed in claim 1, wherein a hydraulic tank (15) is installed on an inner side (10a) of the hydraulic station (10), a bidirectional gear pump (16) is installed on one side (15a) of the hydraulic tank (15), and a third motor (17) is installed on one side (16a) of the bidirectional gear pump (16).

3. The supporting device for use in civil construction as claimed in claim 1, wherein the mounting block (20) comprises a through-hole (20a) and a threaded hole (20b) respectively corresponding to the lead screw (18) and the guiding post (19).

4. (canceled)

5. (canceled)

6. The supporting device for use in civil construction as claimed in claim 2, wherein the hydraulic tank (15) comprises an oil port (15b) formed on the top (15a) thereof, and a sealing cover (15c) covered onto the oil port (15b).
